(19) United States
(12) Patent Application Publication
(10) Pub. No.: US 2026/0084976 A1
(43) Pub. Date: Mar. 26, 2026

(54) Readily soluble alumina and method for preparing the same

(71) Applicant: ZHENGZHOU NON-FERROUS METALS RESEARCH INSTITUTE CO.LTD OF CHALCO, Zhengzhou (CN)

(72) Inventors: Zhonglin YIN, Zhengzhou (CN); Shuai SHAO, Zhengzhou (CN); Huibin YANG, Zhengzhou (CN); Guobao WU, Zhengzhou (CN); Xiaotao LU, Zhengzhou (CN); Chengyu LI, Zhengzhou (CN); Jie ZHENG, Zhengzhou (CN)

(73) Assignee: ZHENGZHOU NON-FERROUS METALS RESEARCH INSTITUTE CO.LTD OF CHALCO, Zhengzhou, HE (CN)

(21) Appl. No.: 19/403,670

(22) Filed: Nov. 28, 2025

Related U.S. Application Data
(63) Continuation of application No. PCT/CN2024/107762, filed on Jul. 26, 2024.

(30) Foreign Application Priority Data
Apr. 1, 2024 (CN) 202410383653.6

(51) Int. Cl. C01F 7/441

(52) U.S. Cl. CPC C01F 7/441; C01P 2004/03; C01P 2006/12

(57) ABSTRACT

A readily soluble alumina and a method for preparing the same involve: mixing an aluminum hydroxide and a sodium aluminate solution to obtain an aluminum hydroxide slurry; performing a high-temperature reaction on the aluminum hydroxide slurry to obtain an alumina hydrate; and performing a low-temperature calcination on the alumina hydrate to obtain a readily soluble alumina.

### CROSS-REFERENCE TO RELATED APPLICATION

This is a continuation of International Application No. PCT/CN2024/107762, filed on Jul. 26, 2024, which claims priority to Chinese Patent Application No. 2024103836536, filed on Apr. 1, 2024. The disclosures of the above-referenced applications are hereby incorporated by reference in their entireties.

### TECHNICAL FIELD

The disclosure relates to the technical field of alumina production, and in particular to a readily soluble alumina and a method for preparing the same.

### BACKGROUND

A production of alumina and a production of electrolytic aluminum are two key production processes in an aluminum smelting industry. Alumina with poor dissolution performance, after being added to an electrolyte melt, has a low dissolution rate and is easily precipitated. It will make an operation of an aluminum electrolysis cell unstable or induce an anode effect, thereby reducing current efficiency, increasing an energy consumption and material consumption, and increasing a greenhouse gas emission of Perfluorocarbons (PFCs), and thus not only a production of aluminum electrolysis is affected but also the environment is polluted.

A dissolution rate of alumina is an important evaluation index of dissolution performance. The dissolution rate is mainly related to physical properties of alumina such as a particle size, α-Al₂O₃ content, microstructure, and a wetted condition of alumina during aluminum electrolysis. In the aluminum electrolytic cell, an alumina is first spread out on a surface of an electrolyte melt and is initially in a floating state. When an alumina with good physical properties comes into contact with the electrolyte melt, a thin solidified shell appears on a bottom of the alumina, while an upper portion of the alumina is in a dry state. The alumina stays on the surface of the electrolyte melt and is gradually wetted by the electrolyte melt extending from bottom to top. This is advantageous to increase the dissolution rate of the alumina. An alumina with poor physical properties directly sinks to a bottom of the electrolytic cell and be mixed with a molten aluminum together, causing the dissolution rate of alumina to be greatly reduced, resulting in unstable operation and low current efficiency of the electrolytic cell. Currently, there is no report in the relevant technology on how to prepare an alumina with good physical properties.

### SUMMARY

By utilizing one or more embodiments of the disclosure, a technical problem of low dissolution rate of an alumina during electrolysis, resulting in unstable operation and low current efficiency of an electrolytic cell, is solved.

In a first aspect, a method for preparing a readily soluble alumina according to some embodiments of the disclosure, includes the following steps: mixing an aluminum hydroxide and a sodium aluminate solution to obtain an aluminum hydroxide slurry; performing a high-temperature reaction on the aluminum hydroxide slurry to obtain an alumina hydrate; and performing a low-temperature calcination on the alumina hydrate to obtain a readily soluble alumina.

In a second aspect, a readily soluble alumina according to some embodiments of the disclosure is prepared by the method for preparing the readily soluble alumina described in the first aspect.

### BRIEF DESCRIPTION OF DRAWINGS

The accompanying drawings, which are incorporated in and constitute a portion of this specification, illustrate embodiments consistent with the disclosure and, together with the description, serve to explain the principles of the disclosure.

In order to more clearly illustrate the embodiments of the disclosure or the technical solutions in the related art, the drawings required for use in the embodiments or the description of the related art will be briefly introduced below. Obviously, for those skilled in the art, other accompanying drawings can be obtained based on these accompanying drawings without paying any creative labor.

FIG. 1 shows a flow chart of a method for preparing a readily soluble alumina according to some embodiments of the disclosure;

FIG. 2 shows a process block diagram of the method for preparing the readily soluble alumina according to some embodiments of the disclosure;

FIG. 3 shows an electron microscope scanning image of the readily soluble alumina prepared according to the method for preparing the readily soluble alumina according to some embodiments of the disclosure.

### DETAILED DESCRIPTION

In order to make the purposes, technical solutions and advantages of the embodiments of the disclosure clearer, the technical solutions in the embodiments of the disclosure will be clearly and completely described below in conjunction with the accompanying drawings in the embodiments of the disclosure. Obviously, the described embodiments are only a portion of embodiments of the disclosure, not all the embodiments. Based on the embodiments in the disclosure, all other embodiments obtained by ordinary technicians in the field without making any creative work shall fall within the scope of protection of the disclosure.

Various embodiments of the disclosure may exist in the form of a range; it should be understood that the description in the form of a range is only for convenience and simplicity and should not be understood as a hard limit to the scope of the disclosure; therefore, the described range should be considered to have specifically disclosed all possible subranges as well as the single values within such a range. For example, a description of a range from 1 to 6 should be considered to have disclosed subranges, such as from 1 to 3, from 1 to 4, from 1 to 5, from 2 to 4, from 2 to 6, and from 3 to 6, and a single number within the stated range, such as 1, 2, 3, 4, 5, and 6, which applies regardless of the range. Additionally, whenever a numerical range is indicated herein, it is intended to include any cited number (fractional or whole) within the indicated range.

In the disclosure, unless otherwise stated, the terms including, “comprising”, “including”, and the like mean “including but not limited to”. In the disclosure, relational terms such as “first” and “second” are merely used to distinguish one entity or operation from another and do not necessarily require or imply any such actual relationship or sequence among these entities or operations. In the disclosure, “at least one” refers to one or more, and “plurality” refers to two or more. “At least one”, “at least one of the following” or similar expressions thereof refers to any combination of these items, including single items or any combination of plural items. For example, “at least one of a, b, or c”, or “at least one of a, b, and c” can mean: a, b, c, a-b (that is, a and b), a-c, b-c, or a-b-c, where a, b, and c can each be single or multiple.

Unless otherwise specified, various raw materials, reagents, instruments and apparatuses used in the disclosure can be purchased from the market or prepared by existing methods.

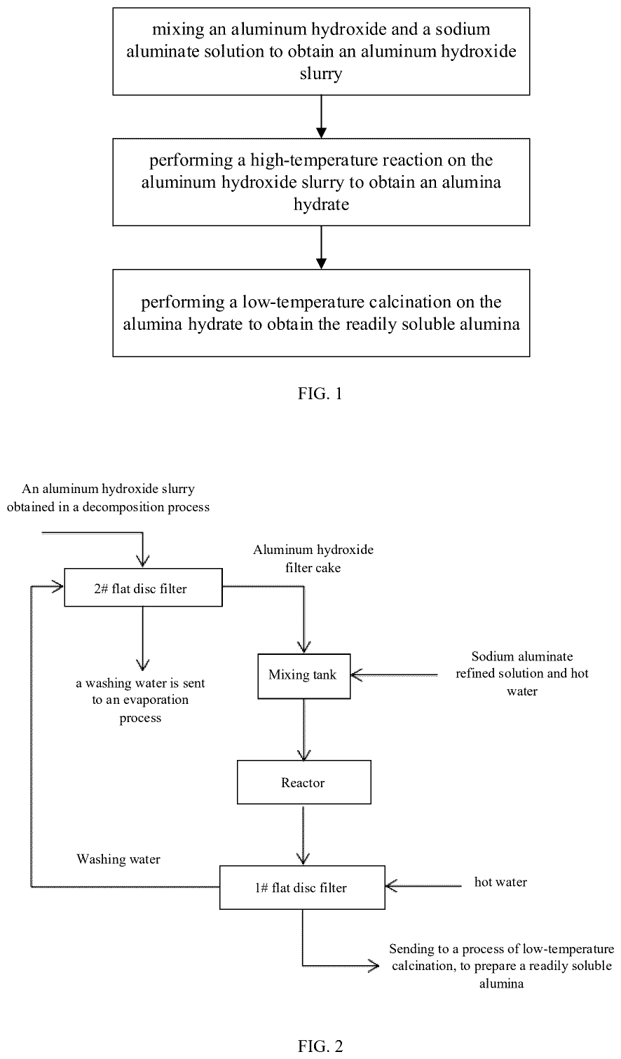

In a first aspect, a method for preparing a readily soluble alumina according to some embodiments of the disclosure, as shown in FIG. 1, includes the following steps:
mixing an aluminum hydroxide and a sodium aluminate solution to obtain an aluminum hydroxide slurry;
performing a high-temperature reaction on the aluminum hydroxide slurry to obtain an alumina hydrate;
performing a low-temperature calcination on the alumina hydrate to obtain a readily soluble alumina.

In the above embodiment, the aluminum hydroxide and sodium aluminate solution are used as raw materials, and the readily soluble alumina can be obtained through a simple high-temperature reaction and low-temperature calcination. A structure of the readily soluble alumina can be changed, thereby making a dissolution rate of the readily soluble alumina faster.

As an optional embodiment, a source of the aluminum hydroxide is an aluminum hydroxide obtained by industrial decomposition. The aluminum hydroxide obtained by industrial decomposition can be separated and washed by a flat disc filter to remove impurities, thereby obtaining the aluminum hydroxide used in the embodiments of the disclosure. In some embodiments, the aluminum hydroxide can also be purchased from the market.

As an optional embodiment, the mixing the aluminum hydroxide and the sodium aluminate solution to obtain the aluminum hydroxide slurry may include: mixing an aluminum hydroxide separated and washed by a flat disc filter with a sodium aluminate solution in a mixing tank to form an aluminum hydroxide slurry. The aluminum hydroxide slurry can then be transported into a reactor via a slurry pump for subsequent high-temperature reaction.

As an optional embodiment, a concentration of a caustic alkali (Na₂O_{K}) in the sodium aluminate solution is 5 g/L-10 g/L, and a caustic ratio (x) of the sodium aluminate solution is 1.35-1.60, where, the caustic ratio (α_{K}) of the sodium aluminate solution is a molecular ratio of the caustic alkali (Na₂O_{K}) to the alumina (Al₂O₃) that are contained in the sodium aluminate solution.

In the above embodiment, by limiting the concentration of the caustic alkali in the sodium aluminate solution to range from 5 g/L to 10 g/L and limiting the caustic ratio of the sodium aluminate solution to range from 1.35 to 1.60, the sodium aluminate solution can be limited to be a low-concentration sodium aluminate solution. Since the sodium aluminate solution mainly includes Na₂O—Al₂O₃—H₂O, a purpose of selecting the low-concentration sodium aluminate solution is in that when the high-temperature reaction is performed on the aluminum hydroxide slurry, the aluminum hydroxide is first dissolved and transformed in water to form a new crystal nuclei, and a structure of the aluminum hydroxide is changed. At the same time, the aluminum hydroxide generated by a decomposition reaction of aluminate ions in the sodium aluminate solution is induced to be precipitated on the above-mentioned new crystal nuclei, promoting an agglomeration and growth of the aluminum hydroxide on the new crystal nuclei to achieve a lattice transformation of the aluminum hydroxide and coarsen a particle size of the aluminum hydroxide. In the whole process of the lattice transformation of the aluminum hydroxide, the caustic alkali in the sodium aluminate solution enters into a lattice of the aluminum hydroxide, and thus the low-concentration sodium aluminate solution, due to its own low content of caustic alkali, can ensure that a content of the impurity, caustic alkali, in a finally obtained readily soluble alumina does not increase. If a concentration of caustic alkali in the sodium aluminate solution is too high, the content of the impurity, caustic alkali in the finally obtained readily soluble alumina will exceed standards; if the low-concentration sodium aluminate solution is not used in a preparation step of the aluminum hydroxide slurry, and the aluminum hydroxide is directly dissolved in water to prepare the aluminum hydroxide slurry, the above-mentioned reaction process will not occur, and a dissolution performance of the finally prepared ordinary alumina will be poor.

In the above embodiment, the low-concentration sodium aluminate solution can also be obtained by diluting a sodium aluminate refined solution with a higher concentration purchased on the market. The sodium aluminate refined solution can be diluted 15 to 30 times with hot water to obtain the low-concentration sodium aluminate solution.

As an optional embodiment, a solid content of the aluminum hydroxide slurry is 100 g/L to 600 g/L, that is, in 1 L of aluminum hydroxide slurry, a content of aluminum hydroxide is 100 g to 600 g.

In the above embodiment, limiting the solid content of the aluminum hydroxide slurry helps to determine a content of the aluminum hydroxide in the aluminum hydroxide slurry, to ensure a product content in subsequent processes of the high-temperature reaction and the low-temperature calcination. At the same time, the limiting the solid content of the aluminum hydroxide slurry can also ensure a structure of prepared readily soluble alumina and ensure that an obtained readily soluble alumina has ready solubility.

In some embodiments, the solid content of the aluminum hydroxide slurry may be 100 g/L, 200 g/L, 300 g/L, 400 g/L, 500 g/L or 600 g/L.

As an optional embodiment, a reaction temperature of the high-temperature reaction ranges from 190° C.-240° C.

A reason for limiting the reaction temperature of the high-temperature reaction to range from 190° C.-240° C. is that, at this reaction temperature of the high-temperature reaction, sodium aluminate ions in the aluminum hydroxide slurry have higher reaction kinetic energy. The sodium aluminate ions, after collisions among them, are more likely to break through a solvation film and release a lattice energy, and in turn a surface and an internal structure of the aluminum hydroxide can be can changed within a certain period of time, to form the alumina hydrate with good crystallization properties.

As an optional embodiment, the reaction time of the high-temperature reaction ranges from 10 min to 60 min.

The reaction time of the high-temperature reaction is related to the reaction temperature of the high-temperature reaction and is also related to the solid content of the aluminum hydroxide slurry to a certain extent. Optionally, the reaction time of the high-temperature reaction can range from 10 min to 60 min. The reaction time of the high-temperature reaction can be adjusted to be 10 min, 20 min, 30 min, 40 min, 50 min, or 60 min according to an actual reaction process.

The reason for limiting the reaction time of the high-temperature reaction to 10 min to 60 min is that: if the reaction time of the high-temperature reaction is too short, the structure of the aluminum hydroxide cannot be completely transformed, and a dissolution performance of an obtained alumina is not effectively improved; if the reaction time of the high-temperature reaction is too long, an amount of the new crystal nuclei, formed through an excessive dissolution and transformation of the aluminum hydroxide, is too large, thereby leading to a refinement of the particle size of the aluminum hydroxide hydrate, thereby affecting the dissolution performance of a subsequently generated alumina.

As an optional embodiment, the performing the high-temperature reaction on the aluminum hydroxide slurry to obtain the alumina hydrate includes:
performing a high-temperature reaction on the aluminum hydroxide slurry to obtain an alumina hydrate slurry;
performing a solid-liquid separation on the alumina hydrate slurry to obtain an alumina-hydrate filter residue;
washing the alumina-hydrate filter residue to obtain an alumina hydrate.

In the above embodiment, after the alumina hydrate slurry is obtained, a solid-liquid separation and washing can be performed on the alumina hydrate slurry through a flat disc filter. An excess solution in the alumina hydrate slurry can be removed by the solid-liquid separation, and impurities in the alumina-hydrate filter residue can be removed by washing, thereby obtaining an alumina hydrate with higher purity. In some embodiments, a hot water may be used to wash the alumina-hydrate filter residue. In some embodiments, a temperature of the hot water may range from 30° C. to 70° C.

As an optional embodiment, a temperature of the low-temperature calcination ranges from 550° C.-750° C.

In the above embodiment, the low-temperature calcination is performed on the alumina hydrate. With the temperature of the low-temperature calcination set to range from 550° C.-750° C., it can be ensured that the alumina hydrate is decomposed into the readily soluble alumina, and at the same time, the readily soluble alumina obtained by the low-temperature calcination has a special structure, which can improve a solubility of the readily soluble alumina. In addition, the low-temperature calcination can also save an energy consumption of the calcination. The energy consumption of the calcination can be reduced by more than 30%.

In a second aspect, based on a general inventive concept, a readily soluble alumina is provided according to an embodiment of the disclosure. The readily soluble alumina is prepared by the method for preparing the readily soluble alumina described in the first aspect.

The readily soluble alumina is realized based on the method for preparing the readily soluble alumina mentioned above. Specific steps of the method for preparing can refer to the above embodiments. Since the readily soluble alumina adopts a portion or all of the technical solutions of the above embodiment, it at least has all the advantageous effects brought by the technical solutions of the above embodiment, which will not be described one by one here.

As an optional embodiment, a microstructure of the readily soluble alumina is a quasi-spherical structure whose surface is covered by a large number of flakes.

As an optional embodiment, the readily soluble alumina includes at least one of the following properties: a repose angle ranging from 25 degrees to 28 degrees, α-Al₂O₃ not contained, a specific surface area ranging from 60 m²/g-100 m²/g, and an apparent density ranging from 0.5 g/cm³-0.8 g/cm³.

As an optional embodiment, compared with ordinary alumina, a content of a particle size less than 20 m in the readily soluble alumina can be reduced to be 0, and a content of a particle size less than 45 m in the readily soluble alumina is less than 10%. The content of the particle size less than 45 m in the readily soluble alumina of the disclosed embodiments is significantly reduced compared to a content of a particle size below 45 m in ordinary metallurgical grade alumina. The content of the particle size less than 45 m in the readily soluble alumina of the disclosed embodiments can be reduced by 40% to 80%.

In the above-mentioned embodiment, the structure of the obtained readily soluble alumina increases its dissolution rate by more than 40% compared with ordinary alumina.

The technical solution of the disclosure is further described below in conjunction with specific examples. It should be understood that these examples are only used to illustrate the disclosure but are not used to limit the scope of the disclosure. The experimental methods without specific conditions in the following examples are usually measured in accordance with industry standards. If there are no corresponding industry standards, the experimental methods without specific conditions in the following examples are proceeded according to the general international standards, conventional conditions, or the conditions recommended by the manufacturer.

### Example 1

This example discloses a method for preparing a readily soluble alumina, as shown in FIG. 2, including the following steps that:
a low-concentration sodium aluminate solution is prepared by using a sodium aluminate refined solution and hot water, where a concentration of a caustic alkali of the sodium aluminate refined solution is 150 g/L and a caustic ratio of the sodium aluminate refined solution is 1.45. The sodium aluminate refined solution is diluted 30 times with hot water to obtain a low-concentration sodium aluminate solution with a concentration of a caustic alkali of 5 g/L and a caustic ratio of 1.45.

An aluminum hydroxide slurry obtained in a decomposition process of an alumina plant is separated and washed by a 2 #flat disc filter to obtain an aluminum hydroxide solid. The aluminum hydroxide solid and the low-concentration sodium aluminate solution are placed in a mixing tank for mixing to obtain an aluminum hydroxide slurry with a solid content of 600 g/L; a washing water generated by a separation and washing performed by the 2 #flat disc filter on the aluminum hydroxide slurry is sent to an evaporation process for recovery.

The aluminum hydroxide slurry is transported into an autoclave reactor through a slurry pump for a high-temperature reaction, with a reaction temperature of 240° C., for 10 min to obtain an alumina hydrate slurry.

The alumina hydrate slurry obtained by the high-temperature reaction is separated and washed by a 1 #flat disc filter to obtain an alumina hydrate; the 1 #flat disc filter can use a hot water to wash the alumina hydrate; a washing water generated by a separation and washing performed by the 1 #flat disc filter on the alumina hydrate slurry is transported to the 2 #flat disc filter for washing the aluminum hydroxide slurry.

An alumina hydrate is placed in a muffle furnace to be subjected to a low-temperature calcination at a temperature of 750° C. of the low-temperature calcination, to obtain a readily soluble alumina.

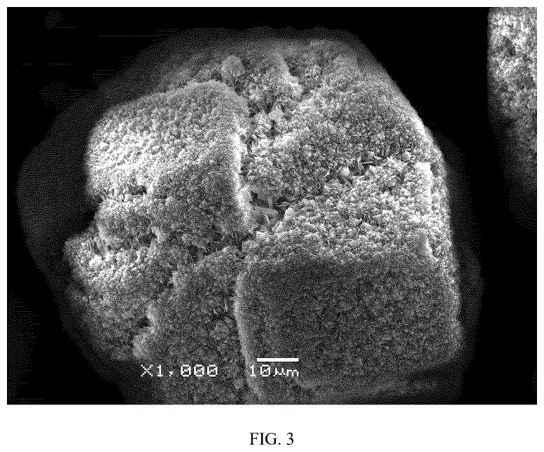

A structure and particle size of a prepared readily soluble alumina are characterized, where in the readily soluble alumina particles, a percentage content of the readily soluble alumina particles with a particle size −20 μm is 0, a percentage content of the readily soluble alumina particles with a particle size −45 μm is 5%; the readily soluble alumina particles have a repose angle of 26°, an α-Al₂O₃ content of 0, a specific surface area of 90 m²/g, an apparent density of 0.65 g/cm³, and a Na₂O content of 0.30%; and a crystal form of the readily soluble alumina is a quasi-spherical structure covered with a large number of flakes, as shown in FIG. 3.

A solubility test of the prepared readily soluble alumina is carried out that: 0.2 g of the readily soluble alumina is added into 40 g of an electrolyte system at a constant temperature of 950° C., and a dissolution time is measured to be 45 s.

### Example 2

This example discloses a method for preparing a readily soluble alumina, as shown in FIG. 2, including the following steps that:

a low-concentration sodium aluminate solution is prepared by using a sodium aluminate refined solution and hot water, where a concentration of a caustic alkali of the sodium aluminate refined solution is 150 g/L and a caustic ratio of the sodium aluminate refined solution is 1.45. The sodium aluminate refined solution is diluted 30 times with hot water to obtain a low-concentration sodium aluminate solution with a concentration of a caustic alkali of 5 g/L and a caustic ratio of 1.45.

An aluminum hydroxide slurry obtained in a decomposition process of an alumina plant is separated and washed by a 2 #flat disc filter to obtain an aluminum hydroxide solid. The aluminum hydroxide solid and the low-concentration sodium aluminate solution are placed in a mixing tank for mixing to obtain an aluminum hydroxide slurry with a solid content of 600 g/L; a washing water generated by a separation and washing performed by the 2 #flat disc filter on the aluminum hydroxide slurry is transported to an evaporation process for recovery.

The aluminum hydroxide slurry is transported into an autoclave reactor through a slurry pump for a high-temperature reaction, with a reaction temperature of 190° C., for 10 min to obtain an alumina hydrate slurry.

The alumina hydrate slurry obtained by the high-temperature reaction is separated and washed by a 1 #flat disc filter to obtain an alumina hydrate; the 1 #flat disc filter can use a hot water to wash the alumina hydrate; a washing water generated by a separation and washing performed by the 1 #flat disc filter on the alumina hydrate slurry is transported to the 2 #flat disc filter for washing the aluminum hydroxide slurry.

An alumina hydrate is placed in a muffle furnace to be subjected to a low-temperature calcination at a temperature of 750° C. of the low-temperature calcination, and then to obtain a readily soluble alumina.

A structure and particle size of a prepared readily soluble alumina are characterized, where in the readily soluble alumina particles, a percentage content of the readily soluble alumina particles with a particle size −20 μm is 0, a percentage content of the readily soluble alumina particles with a particle size −45 μm is 6%; the readily soluble alumina particles have a repose angle of 27°, an α-Al₂O₃ content of 0, a specific surface area of 88 m²/g, an apparent density of 0.68 g/cm³, and a Na₂O content of 0.31%; and a crystal form of the readily soluble alumina is a quasi-spherical structure covered with a large number of flakes.

A solubility test of the prepared alumina is carried out that: 0.2 g of the readily soluble alumina is added into 40 g of an electrolyte system at a constant temperature of 950° C., and a dissolution time is measured to be 50 s.

### Example 3

This example discloses a method for preparing a readily soluble alumina, as shown in FIG. 2, including the following steps that:

a low-concentration sodium aluminate solution is prepared by using a sodium aluminate refined solution and hot water, where a concentration of a caustic alkali of the sodium aluminate refined solution is 150 g/L and a caustic ratio of the sodium aluminate refined solution is 1.43. The sodium aluminate refined solution is diluted 15 times with hot water to obtain a low-concentration sodium aluminate solution with a concentration of a caustic alkali of 10 g/L and a caustic ratio of 1.43.

An aluminum hydroxide slurry obtained in a decomposition process of an alumina plant is separated and washed by a 2 #flat disc filter to obtain an aluminum hydroxide solid. The aluminum hydroxide solid and the low-concentration sodium aluminate solution are placed in a mixing tank for mixing to obtain an aluminum hydroxide slurry with a solid content of 600 g/L; a washing water generated by a separation and washing performed by the 2 #flat disc filter on the aluminum hydroxide slurry is transported to an evaporation process for recovery.

The aluminum hydroxide slurry is transported into an autoclave reactor through a slurry pump for a high-temperature reaction, with a reaction temperature of 240° C., for 10 min to obtain an alumina hydrate slurry.

The alumina hydrate slurry obtained by the high-temperature reaction is separated and washed by a 1 #flat disc filter to obtain an alumina hydrate; the 1 #flat disc filter can use a hot water to wash the alumina hydrate; a washing water generated by a separation and washing performed by the 1 #flat disc filter on the alumina hydrate slurry is transported to the 2 #flat disc filter for washing the aluminum hydroxide slurry.

An alumina hydrate is placed in a muffle furnace to be subjected to a low-temperature calcination at a temperature of 750° C. of the low-temperature calcination, to obtain a readily soluble alumina.

A structure and particle size of a prepared readily soluble alumina are characterized, where in the readily soluble alumina particles, a percentage content of the readily soluble alumina particles with a particle size −20 μm is 0, a percentage content of the readily soluble alumina particles with a particle size −45 μm is 4%; the readily soluble alumina particles have a repose angle of 27°, an α-Al₂O₃ content of 0, a specific surface area of 92 m²/g, an apparent density of 0.66 g/cm³, and a Na₂O content of 0.36%; and a crystal form of the readily soluble alumina is a quasi-spherical structure covered with a large number of flakes.

A solubility test of the prepared readily soluble alumina is carried out that: 0.2 g of the readily soluble alumina is added into 40 g of an electrolyte system at a constant temperature of 950° C., and a dissolution time is measured to be 40 s.

### Example 4

This example discloses a method for preparing a readily soluble alumina, as shown in FIG. 2, including the following steps that:

a low-concentration sodium aluminate solution is prepared by using a sodium aluminate refined solution and hot water, where a concentration of a caustic alkali of the sodium aluminate refined solution is 150 g/L and a caustic ratio of the sodium aluminate refined solution is 1.41. The sodium aluminate refined solution is diluted 30 times with hot water to obtain a low-concentration sodium aluminate solution with a concentration of a caustic alkali of 5 g/L and a caustic ratio of 1.41.

An aluminum hydroxide slurry obtained in a decomposition process of an alumina plant is separated and washed by a 2 #flat disc filter to obtain an aluminum hydroxide solid. The aluminum hydroxide solid and the low-concentration sodium aluminate solution are placed in a mixing tank for mixing to obtain an aluminum hydroxide slurry with a solid content of 600 g/L; a washing water generated by a separation and washing performed by the 2 #flat disc filter on the aluminum hydroxide slurry is transported to an evaporation process for recovery.

The aluminum hydroxide slurry is transported into an autoclave reactor through a slurry pump for a high-temperature reaction, with a reaction temperature of 240° C., for 10 min to obtain an alumina hydrate slurry.

The alumina hydrate slurry obtained by the high-temperature reaction is separated and washed by a 1 #flat disc filter to obtain an alumina hydrate; the 1 #flat disc filter can use a hot water to wash the alumina hydrate; a washing water generated by a separation and washing performed by the 1 #flat disc filter on the alumina hydrate slurry is transported to the 2 #flat disc filter for washing the aluminum hydroxide slurry.

An alumina hydrate is placed in a muffle furnace to be subjected to a low-temperature calcination at a temperature of 650° C. of the low-temperature calcination, to obtain a readily soluble alumina.

A structure and particle size of a prepared readily soluble alumina are characterized, where in the readily soluble alumina particles, a percentage content of the readily soluble alumina particles with a particle size −20 μm is 0, a percentage content of the readily soluble alumina particles with a particle size −45 μm is 5%; the readily soluble alumina particles have a repose angle of 28°, an α-Al₂O₃ content of 0, a specific surface area of 88 m²/g, an apparent density of 0.68 g/cm³, and a Na₂O content of 0.30%; and a crystal form of the readily soluble alumina is a quasi-spherical structure covered with a large number of flakes.

A solubility test of the prepared readily soluble alumina is carried out that: 0.2 g of the readily soluble alumina is added into 40 g of an electrolyte system at a constant temperature of 950° C., and a dissolution time is measured to be 46 s.

### Example 5

This example discloses a method for preparing a readily soluble alumina, as shown in FIG. 2, including the following steps that:

a low-concentration sodium aluminate solution is prepared by using a sodium aluminate refined solution and hot water, where a concentration of a caustic alkali of the sodium aluminate refined solution is 150 g/L and a caustic ratio of the sodium aluminate refined solution is 1.45. The sodium aluminate refined solution is diluted 30 times with hot water to obtain a low-concentration sodium aluminate solution with a concentration of a caustic alkali of 5 g/L and a caustic ratio of 1.45.

An aluminum hydroxide slurry obtained in a decomposition process of an alumina plant is separated and washed by a 2 #flat disc filter to obtain an aluminum hydroxide solid. The aluminum hydroxide solid and the low-concentration sodium aluminate solution are placed in a mixing tank for mixing to obtain an aluminum hydroxide slurry with a solid content of 100 g/L; a washing water generated by a separation and washing performed by the 2 #flat disc filter on the aluminum hydroxide slurry is transported to an evaporation process for recovery.

The aluminum hydroxide slurry is transported into an autoclave reactor through a slurry pump for a high-temperature reaction, with a reaction temperature of 240° C., for 10 min to obtain an alumina hydrate slurry.

The alumina hydrate slurry obtained by the high-temperature reaction is separated and washed by a 1 #flat disc filter to obtain an alumina hydrate; the 1 #flat disc filter can use a hot water to wash the alumina hydrate; a washing water generated by a separation and washing performed by the 1 #flat disc filter on the alumina hydrate slurry is transported to the 2 #flat disc filter for washing the aluminum hydroxide slurry.

An alumina hydrate is placed in a muffle furnace to be subjected to a low-temperature calcination at a temperature of 750° C. of the low-temperature calcination, to obtain a readily soluble alumina.

A structure and particle size of a prepared readily soluble alumina are characterized, where in the readily soluble alumina particles, a percentage content of the readily soluble alumina particles with a particle size −20 μm is 0, a percentage content of the readily soluble alumina particles with a particle size −45 μm is 7%; the readily soluble alumina particles have a repose angle of 27°, an α-Al₂O₃ content of 0, a specific surface area of 84 m²/g, an apparent density of 0.68 g/cm³, and a Na₂O content of 0.31%; and a crystal form of the readily soluble alumina is a quasi-spherical structure covered with a large number of flakes.

A solubility test of the prepared readily soluble alumina is carried out that: 0.2 g of the readily soluble alumina is added into 40 g of an electrolyte system at a constant temperature of 950° C., and a dissolution time is measured to be 50 s.

### Example 6

This example discloses a method for preparing a readily soluble alumina, as shown in FIG. 2, including the following steps that:

a low-concentration sodium aluminate solution is prepared by using a sodium aluminate refined solution and hot water, where a concentration of a caustic alkali of the sodium aluminate refined solution is 150 g/L and a caustic ratio of the sodium aluminate refined solution is 1.45. The sodium aluminate refined solution is diluted 30 times with hot water to obtain a low-concentration sodium aluminate solution with a concentration of a caustic alkali of 5 g/L and a caustic ratio of 1.45.

An aluminum hydroxide slurry obtained in a decomposition process of an alumina plant is separated and washed by a 2 #flat disc filter to obtain an aluminum hydroxide solid. The aluminum hydroxide solid and the low-concentration sodium aluminate solution are placed in a mixing tank for mixing to obtain an aluminum hydroxide slurry with a solid content of 600 g/L; a washing water generated by a separation and washing performed by the 2 #flat disc filter on the aluminum hydroxide slurry is transported to an evaporation process for recovery.

The aluminum hydroxide slurry is transported into an autoclave reactor through a slurry pump for a high-temperature reaction, with a reaction temperature of 240° C., for 60 min to obtain an alumina hydrate slurry.

The alumina hydrate slurry obtained by the high-temperature reaction is separated and washed by a 1 #flat disc filter to obtain an alumina hydrate; the 1 #flat disc filter can use a hot water to wash the alumina hydrate; a washing water generated by a separation and washing performed by the 1 #flat disc filter on the alumina hydrate slurry is transported to the 2 #flat disc filter for washing the aluminum hydroxide slurry.

An alumina hydrate is placed in a muffle furnace to be subjected to a low-temperature calcination at a temperature of 750° C. of the low-temperature calcination, to obtain a readily soluble alumina.

A structure and particle size of a prepared readily soluble alumina are characterized, where in the readily soluble alumina particles, a percentage content of the readily soluble alumina particles with a particle size −20 μm is 0, a percentage content of the readily soluble alumina particles with a particle size −45 μm is 8%; the readily soluble alumina particles have a repose angle of 27°, an α-Al₂O₃ content of 0, a specific surface area of 91 m²/g, an apparent density of 0.66 g/cm³, and a Na₂O content is 0.30%; and a crystal form of the readily soluble alumina is a quasi-spherical structure covered with a large number of flakes.

A solubility test of the prepared readily soluble alumina is carried out that: 0.2 g of the readily soluble alumina is added into 40 g of an electrolyte system at a constant temperature of 950° C., and a dissolution time is measured to be 58 s.

### Comparative Example

This comparative example discloses a method for preparing an alumina, including the following steps that:

an aluminum hydroxide is directly placed in a muffle furnace to be subjected to a high-temperature calcination at a temperature of 1000° C. of the high-temperature calcination to obtain ordinary alumina.

Obtained ordinary alumina is characterized, where in ordinary alumina particles, a percentage content of the ordinary alumina particles with a particle size −20 μm is 5%, a percentage content of the ordinary alumina particles with a particle size −45 μm is 15%; the ordinary alumina particles have a repose angle of 33°, an α-Al₂O₃ content of 3%, a specific surface area of 75 m²/g, an apparent density of 0.99 g/cm³, a Na₂O content of 0.30%; and a crystal form of the ordinary alumina is an irregular mosaic structure with a smooth surface.

A solubility test of the obtained ordinary alumina is carried out that: 0.2 g of the ordinary alumina is added into 40 g of an electrolyte system at a constant temperature of 950° C., and a dissolution time is measured to be 108 s.

Control parameters of preparation processes disclosed in Examples 1 to 6 and the Comparative Example are compared, performance parameters of the readily soluble alumina obtained in Examples 1 to 6 and performance parameters of the ordinary alumina obtained in the Comparative example are compared, and results are shown respectively in Table 1 and Table 2 below:

TABLE 1
Control parameters of preparation processes of Examples 1 to 6 and Comparative Example

| | Example | Example | Example | Example | Example | Example | Comparative |
|---|---|---|---|---|---|---|---|
| | 1 | 2 | 3 | 4 | 5 | 6 | Example |
| Concentration of caustic | 5 | 5 | 10 | 5 | 5 | 5 | \ |
| soda in sodium aluminate | | | | | | | |
| solution/(g/L) | | | | | | | |
| Molecular ratio | 1.45 | 1.45 | 1.43 | 1.41 | 1.45 | 1.45 | \ |
| Solid content in aluminum | 600 | 600 | 600 | 600 | 100 | 600 | \ |
| hydroxide slurry/(g/L) | | | | | | | |
| Reaction temperature/° C. | 240 | 190 | 240 | 240 | 240 | 240 | \ |
| Reaction time/min | 10 | 10 | 10 | 10 | 10 | 60 | \ |
| Calcination temperature/° C. | 750 | 750 | 750 | 650 | 750 | 750 | 1000 |

TABLE 2
Performance parameters of readily soluble alumina obtained in Examples
1 to 6 and ordinary alumina obtained in Comparative example

| | Example | Example | Example | Example | Example | Example | Comparative |
|---|---|---|---|---|---|---|---|
| | 1 | 2 | 3 | 4 | 5 | 6 | Example |
| a percentage of particle | 0 | 0 | 0 | 0 | 0 | 0 | 5 |
| size −20 μm/% | | | | | | | |
| a percentage of particle | 5 | 6 | 4 | 5 | 7 | 8 | 15 |
| size −45 μm/% | | | | | | | |
| Repose angle/degree | 26 | 27 | 27 | 28 | 27 | 27 | 33 |
| α-Al₂O₃ content/% | 0 | 0 | 0 | 0 | 0 | 0 | 3 |
| Specific surface | 90 | 88 | 92 | 88 | 84 | 91 | 75 |
| area/(m²/g) | | | | | | | |
| Apparent density/(g/cm³) | 0.65 | 0.68 | 0.66 | 0.68 | 0.68 | 0.66 | 0.99 |
| Na₂O content/% | 0.30 | 0.31 | 0.36 | 0.30 | 0.31 | 0.30 | 0.30 |
| Dissolution time/s | 45 | 50 | 40 | 46 | 50 | 58 | 108 |

In conjunction with datas in Table 1 and Table 2, it can be known that in the readily soluble alumina prepared by the method for preparing the readily soluble alumina disclosed in Examples 1 to 6, there is no alumina with a particle size less than 20 m, a percentage content of the readily soluble alumina with a particle size less than 45 m is less than 10%; the readily soluble alumina has the repose angle ranging from 25°-28°, no the α-Al₂O₃ contained, the specific surface area ranging from 60 m²/g-100 m²/g, and the apparent density ranging from 0.5 g/cm³-0.8 g/cm³; after the solubility test is performed on the readily soluble alumina, the dissolution time ranges from 45 s-60 s. However, the performance parameters of the ordinary alumina prepared by the method for preparing the ordinary alumina disclosed in the comparative example are relatively poor. After the solubility test is performed on the ordinary alumina, the dissolution time is 108 s. It can be seen that a solubility of the ordinary alumina is much lower than that of the readily soluble alumina prepared in Examples 1 to 6 of the disclosure.

It can be seen from the above embodiments that in the preparation processes of the readily soluble alumina, the method for preparing the readily soluble alumina according to the embodiment of the disclosure can effectively reduce the calcination temperature, optimize the particle size and a structure of the crystal form of the alumina, improve a surface activity (the specific surface area), a dispersibility (the apparent density) and a flowability (the repose angle) of the obtained readily soluble alumina, reduce the α-Al₂O₃ content in the readily soluble alumina, and maintain the Na₂O content in the readily soluble alumina within a reasonable range. By comparing the data of the comparative example with that of the embodiments of the disclosure, it can be seen that when a certain control parameter is not within a range of the embodiments of the disclosure, the performance parameters of the obtained alumina are poor. When various control parameters are within the range of the embodiments of the disclosure, the performance parameters of the readily soluble alumina are better and the dissolution rate is faster.

The readily soluble alumina and method for preparing the same according to some embodiments of the disclosure. The aluminum hydroxide and sodium aluminate are used as raw materials to prepare the aluminum hydroxide slurry. After a high-temperature reaction, the aluminum hydroxide is dissolved and transformed in water to form the new crystal nuclei, and at this time the structure of the aluminum hydroxide begins to be changed. At the same time, the decomposition reaction of the aluminate ions in the sodium aluminate solution occurs, and the generated alumina hydrate is induced to be precipitated on newly generated crystal nuclei, thereby promoting the agglomeration and growth of the new crystal nuclei, coarsening the particle size of the new crystal nuclei, to obtain the alumina hydrate with a special structure. The readily soluble alumina is obtained by the low-temperature calcination performed on the alumina hydrate. The method for preparing according to some embodiments of the disclosure is simple and easy to implement and can not only optimize the particle size and the structure of the crystal form of the readily soluble alumina, but also improve the surface activity, dispersibility, flowability, and dissolution performance of the readily soluble alumina.

The above descriptions are only embodiments of the disclosure enabling those skilled in the art to understand or implement the disclosure. Various modifications to these embodiments will be readily apparent to those skilled in the art, and the generic principle defined in the invention may be practiced in other embodiments without departing from the spirit or scope of the disclosure. Therefore, the disclosure is not to be limited to the embodiments shown in the disclosure but is to be accorded the widest scope consistent with the principles and novel features claimed in the disclosure.

1. A method for preparing a readily soluble alumina, comprising:
mixing an aluminum hydroxide and a sodium aluminate solution to obtain an aluminum hydroxide slurry;
performing a high-temperature reaction on the aluminum hydroxide slurry to obtain an alumina hydrate; and
performing a low-temperature calcination on the alumina hydrate to obtain the readily soluble alumina.

2. The method for preparing the readily soluble alumina according to claim 1, wherein a concentration of a caustic alkali (Na₂O_{K}) in the sodium aluminate solution ranges from 5 g/L to 10 g/L; and a caustic ratio (α_{K}) of the sodium aluminate solution ranges from 1.35 to 1.60.

3. The method for preparing the readily soluble alumina according to claim 1, wherein a solid content of the aluminum hydroxide slurry ranges from 100 g/L to 600 g/L.

4. The method for preparing the readily soluble alumina according to claim 1, wherein a reaction temperature of the high-temperature reaction ranges from 190° C. to 240° C.

5. The method for preparing the readily soluble alumina according to claim 4, wherein a reaction time of the high-temperature reaction ranges from 10 min to 60 min.

6. The method for preparing the readily soluble alumina according to claim 1, wherein the performing the high-temperature reaction on the aluminum hydroxide slurry to obtain the alumina hydrate, comprises:
performing a high-temperature reaction on the aluminum hydroxide slurry to obtain an alumina hydrate slurry;
performing a solid-liquid separation on the alumina hydrate slurry to obtain an alumina-hydrate filter residue;
washing the alumina-hydrate filter residue to obtain the alumina hydrate.

7. The method for preparing the readily soluble alumina according to claim 6, wherein a temperature of the low-temperature calcination ranges from 550° C. to 750° C.

8. A readily soluble alumina, prepared by the method for preparing the readily soluble alumina according to claim 1.

9. The readily soluble alumina according to claim 8, wherein a microstructure of the readily soluble alumina is a quasi-spherical structure whose surface is covered by a large number of flakes.

10. The readily soluble alumina according to claim 8, comprising at least one of the following properties: a repose angle ranging from 25 degrees to 28 degrees, a α-Al₂O₃ not contained, a specific surface area ranging from 60 m²/g to 100 m²/g, and an apparent density ranging from 0.5 g/cm³ to 0.8 g/cm³.
